(19) United States
(12) Patent Application Publication
(10) Pub. No.: US 2009/0007472 A1
(43) Pub. Date: Jan. 8, 2009

(54) Character Emitting Placard

(76) Inventor: Joo-Hyun Kim, Seoul (KR)

Correspondence Address: IPLA P.A., 3580 WILSHIRE BLVD., 17TH FLOOR, LOS ANGELES, CA, 90010, US

(21) Appl. No.: 12/161,313

(22) PCT Filed: Nov. 17, 2006
(86) PCT No.: PCT/KR06/04846

§ 371 Date: Jul. 17, 2008

(30) Foreign Application Priority Data
Feb. 3, 2006 (KR) 10-2006-0010395

(51) Int. Cl. G09F 13/28

(52) U.S. Cl. 40/550

(57) ABSTRACT

A light-emit ting character placard is disclosed. The placard includes: a placard base plate (200) on which light-emitting lamps (30) are arrayed at a certain distance to form characters and are coupled by sealing; a controller (130) supplying power to each light-emit ting lamps (30) and controlling the power; and a back plate (220) covering the entire backside of the placard base plate (200) using a sealing means (230).

### TECHNICAL FIELD

The present invention relates to a placard, and more particularly to a light-emitting character placard configured in such a way that light-emitting lamps are arranged at a certain distance on a base plate to form characters, a controller controls electric power supplied to each light emitting lamp, and a back plate seals the backside of the base plate so that the base plate can receive the light-emitting lamps.

### BACKGROUND ART

In general, a placard is a means made of cloth or vinyl plate, on which printed characters or symbols are hung that convey information to the public. Examples of placards are a bill, a poster, a sign, etc. The conventional placard has printed simple characters and symbols that convey a message. Recently, the placard displays pictures using an actual picture printing method.

However, the conventional placard cannot convey its message to the public at a relatively far distance at night until additional external lights are installed. That is, the conventional placard requires additional lighting devices and cases, which are inconvenient.

### DISCLOSURE

### Technical Problems

Therefore, the present invention has been made in view of the above problems, and it is an object of the present invention to provide a light-emitting character placard with a new concept superior to the conventional placard.

Another object of the present invention is to provide a light-emitting character placard that displays characters using lamps and that is foldable for easy carrying and storage.

A further object of the present invention is to provide a light-emitting character placard displaying light-emitting characters, instead of a luminous method, where the light-emitting character placard employs diffused light-emitting units. These units diffuse the lights of lamps to display the characters with a small number of lamps, thereby reducing manufacturing cost and the weight of the placard.

### Technical Solution

In accordance with an aspect of the present invention, the above and other objects can be accomplished by the provision of a light-emitting character placard configured in such a way that light-emitting lamps are arranged at a certain distance on a base plate to form characters, a controller controls electric power supplied to each light emitting lamp, and a back plate seals the backside of the base plate so that the base plate can receive the light-emitting lamps.

In accordance with another aspect of the present invention, a light-emitting character placard is provided that includes: diffusing light-emitting units, each of which has a bottom surface that forms a flat plane, an inside that forms a core layer 11 transmitting light, and an upper surface that forms a convex surface, each diffusing light-emitting units for diffusing the light of the light-emitting lamps installed on the bottom surface of the convex surface; a placard base plate that arrays the diffusing light-emitting units at a certain distance to form a character; a controller that controls power supplied to each diffusing light-emitting unit coupled to the placard base plate; and a back plate that covers the entire backside of the placard base plate using a sealing means.

In accordance with another aspect of the present invention, a light-emitting character placard is provided that includes: diffusing light-emitting units, each of which has a bottom surface that forms a flat plane, an inside that forms a core layer 11 transmitting light, and an upper surface that forms a convex surface, each a diffusing light-emitting unit for diffusing light of a light-emitting lamp installed on the bottom surface to the convex surface; a placard base plate arraying the diffusing light-emitting units at a certain distance to form a character; a controller that controls power supplied to each diffusing light-emitting unit coupled to the placard base plate; and a back plate that covers the entire backside of the placard base plate using a sealing means.

### DESCRIPTION OF DRAWINGS

The above and other objects, features and other advantages of the present invention will be more clearly understood from the following detailed description taken in conjunction with the accompanying drawings, in which:

FIG. 1 is a front view illustrating an embodiment of a light-emitting character placard according to the present invention;

FIG. 2 is an enlarged cross-sectional view of the light-emitting placard of FIG. 2 taken along lines A-A;

FIG. 3 is an enlarged cross-sectional view of a light-emitting character placard modified from that of FIG. 1, taken along lines A-A;

FIG. 4 is an enlarged cross-sectional view of a light-emitting character placard modified from that of FIG. 3, taken along lines A-A;

FIG. 5 is a view illustrating a circuit for controlling the light-emitting character placard of the present invention;

FIG. 6 is an assembled perspective view illustrating a diffused light-emitting unit used in the light-emitting placard of FIG. 3;

FIG. 7 is a cross-sectional view of FIG. 6 taken along lines B-B;

FIG. 8 is an enlarged cross-sectional view of a primary part of FIG. 7;

FIG. 9 is a top view of an embodiment of a diffused light-emitting unit according to the present invention;

FIG. 10 is a top view of another embodiment of a diffused light-emitting unit according to the present invention;

FIG. 11 is a cross-sectional view illustrating another embodiment of a light-emitting character placard according to the present invention; and

FIG. 12 is an enlarged cross-sectional view of a primary part of FIG. 11.

### BEST MODE

Now, preferred embodiments of the present invention will be described in detail with reference to the annexed drawings.

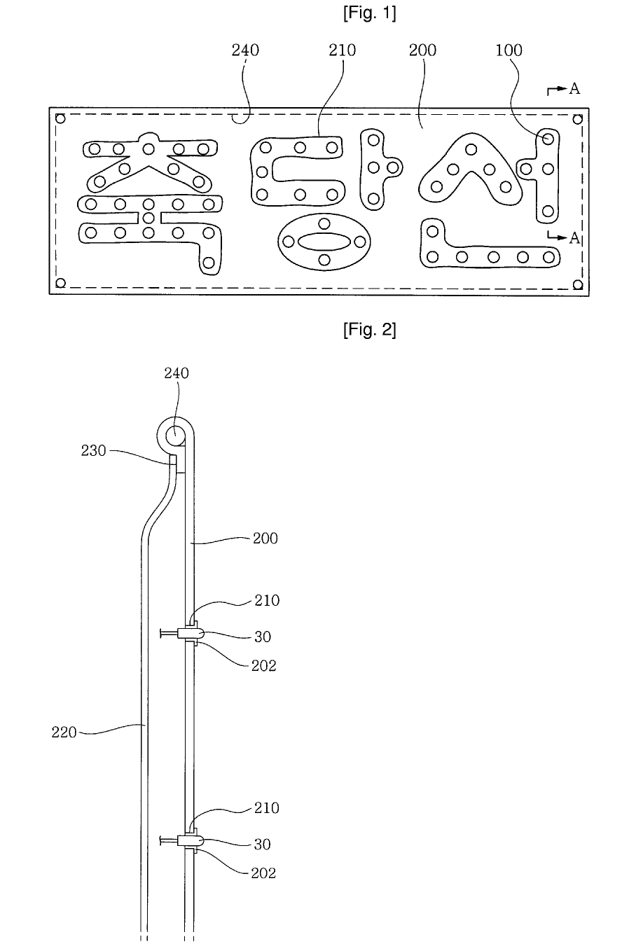

As shown in FIG. 1 of a front view illustrating an embodiment of a light-emitting character placard according to the present invention, and FIG. 2 of an enlarged cross-sectional view of FIG. 2 taken along lines A-A, the light-emitting character placard includes: a placard base plate 200 on which light-emitting lamps 30 are arrayed at a certain distance to form characters and are coupled by a sealing method; a controller 130 that supplies power to each light-emitting lamps 30 and controls the power; and a back plate 220 that covers the entire backside of the placard base plate 200 using a sealing means 230. Here, the placard base plate 200 forms coupling holes 210 to which the light-emitting lamps 30 are inserted and then fixed by a fixing means 202, such as a bond, silicon or other sealing plate, etc. Although the foregoing description explains that the light-emitting lamps 30 coupled to the placard base plate 200 are arrayed to form characters (or letters), it will be easily appreciated that the light-emitting lamps can be variously arrayed to form other symbols, such as figures, numbers, marks, pictures, charters (in a novel or comic book), etc. The base plate 200 and the back plate 220 can be made of waterproof cloth.

In operations, when a switch 131 is turned on, power is supplied from a battery 132 to the light-emitting lamps 30 forming characters. As the controller 130 controls the power supplied to the light-emitting lamps 30, they illuminate to display characters at day and night. As well, since the placard base plate 200 is flexible, the light-emitting character placard can be folded or rolled for easy carrying. Also, because the light-emitting character placard is waterproof, it can be easily unfolded while it rains. The reference number 240 denotes a supporting band for supporting the edge of the placard base plate 200.

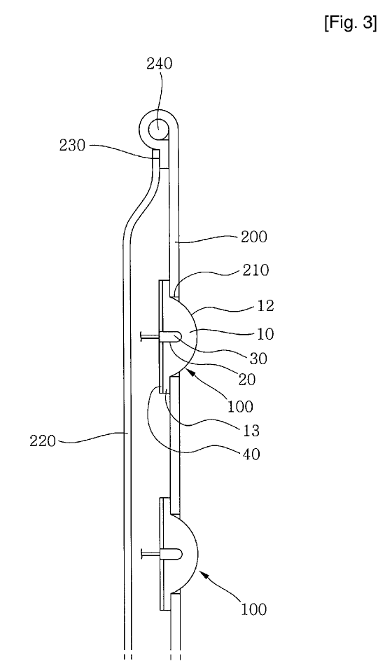

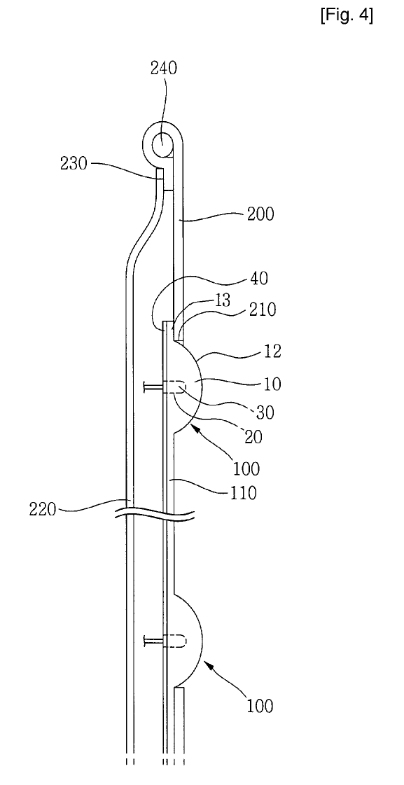

As shown in FIG. 3 of an enlarged cross-sectional view of a light-emitting character placard modified from that of FIG. 1, taken along lines A-A, and FIG. 4 of an enlarged cross-sectional view of FIG. 3, taken along lines A-A, the light-emitting character placard includes: diffusing light-emitting units 100, each of which has a bottom surface that forms a flat plane, an inside that forms a core layer 11 transmitting light, and an upper surface that forms a convex surface, each a diffusing light-emitting unit for diffusing the light of the light-emitting lamps 30 installed on the bottom surface to the convex surface; a placard base plate 200 that arrays the diffusing light-emitting units 100 at a certain distance to form a character; a controller 130 that controls power supplied to each diffusing light-emitting unit 100 coupled to the placard base plate 200; and a back plate 220 that covers the entire backside of the placard base plate 200 using a sealing means 230.

The placard base plate 200 forms coupling holes 210 coupling to and supporting the diffused light-emitting units 100, in such a way that the diffused light-emitting units 100 are spaced apart from each other to be recognizable as a character.

The sealing means 230 is implemented by one of a zipper, a high frequency welder, a magic tape, etc.

The placard base plate 200 couples a supporting band 240 to its edge.

Although the foregoing description explains that the diffused light-emitting units 100 are coupled to the placard base plate 200 to form characters (or letters), it will be easily appreciated that the diffused light-emitting units can be variously arrayed to form other symbols, such as figures, numbers, marks, pictures, charters (in a novel or comic book), etc.

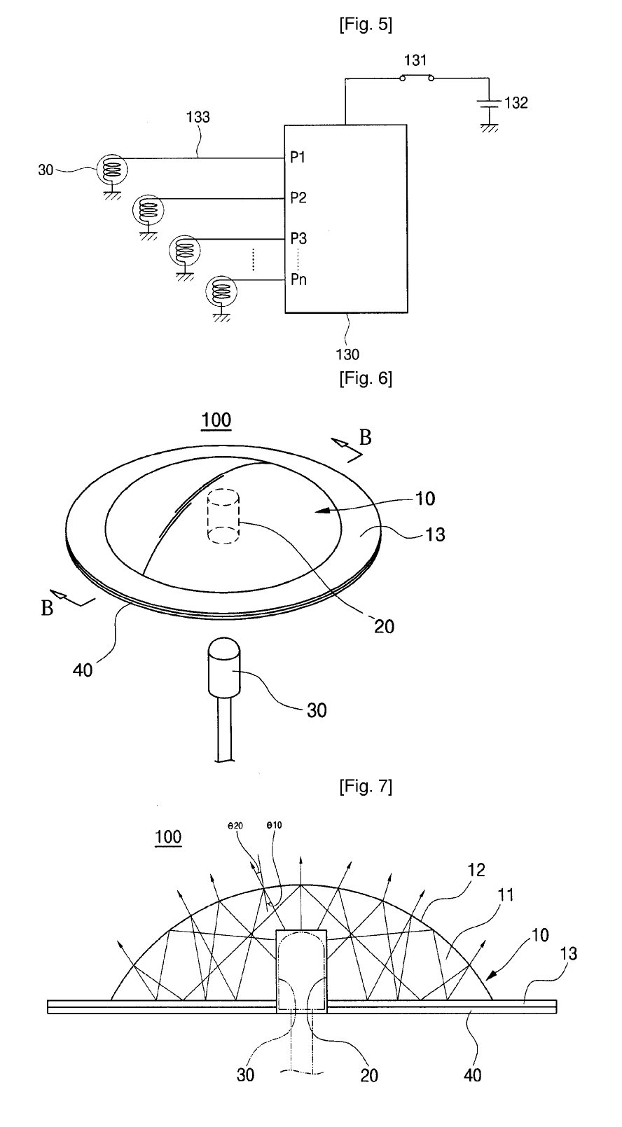

FIG. 5 is a view illustrating a circuit for controlling the light-emitting character placard of the present invention. The detailed description for operations of the light-emitting lamp 30 will be omitted since it is controlled by well-known technology that uses a control circuit. For example, such a control circuit performs a sequential illumination using a shift register, changes emitted light colors of light-emitting lamps 30 or controls a plurality of installed light-emitting lamps, or turns on/off the light-emitting lamps.

The controller 130 inputs power from a battery 132 by a switch 131, and intermittently and continuously supplies the inputted power to the light-emitting lamps 30 through electric lines 133. The controller 130 has a driving program to drive the light-emitting lamps 30 individually, simultaneously, or selectively. Here, the battery 130 is a DC power source, which can be implemented by a commercial battery or an adopter converting AC power to DC power. Also, the battery 130 may be implemented with a solar cell rechargeable by solar energy.

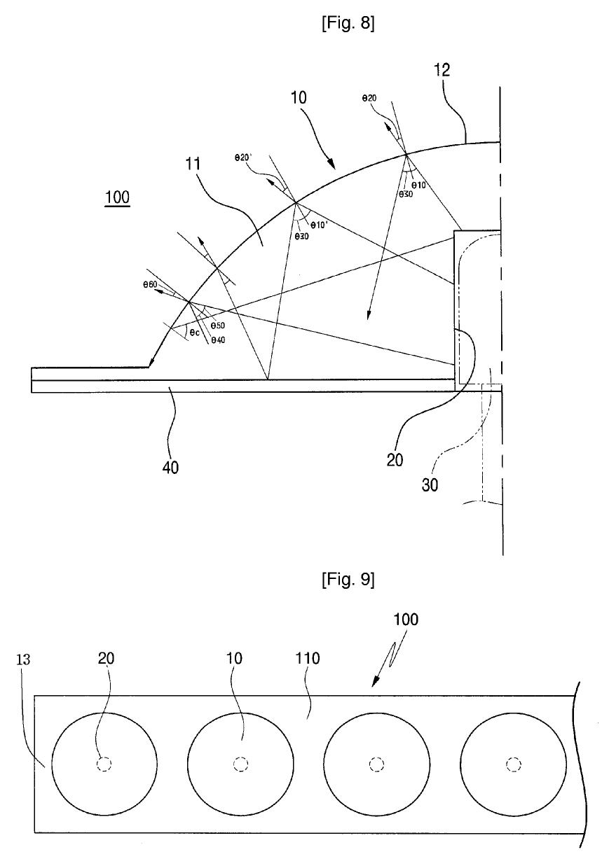

As shown in FIG. 6 of an assembled perspective view illustrating a diffused light-emitting unit used in the light-emitting placard of FIG. 3, FIG. 7 of FIG. 6 taken along lines B-B, and FIG. 8 of an enlarged cross-sectional view of FIG. 7, the diffusing light-emitting unit 100 includes the following:

A convex portion 10 is shaped as a convex lens and made of flexible thermoplastic (thermosetting) polymer to form a clad layer 12 providing a reflection angle to emit light of an internal light source located therein with uniform illumination to upper surface thereof, in which the upper surface forms a convex surface.

An inserting hole 20 is formed at the center of the bottom surface of the convex portion 10 along the axis.

A light-emitting lamp 30 is used as the internal light source, and inserted into the insert hole 20.

A reflection layer 40 is integrally coupled to the flat plane of the bottom surface of the convex unit 10.

Here, a supporting edge unit 13 shaped as a ring-plate for coupling to the placard base plate 200 is integrally coupled to an edge of the convex unit 10.

In addition, as shown in FIG. 9 of a top view of an embodiment of a diffused light-emitting unit of FIG. 4, the diffused light-emitting units 100 are integrally mounted at a certain distance on a flexible polymer base plate 110.

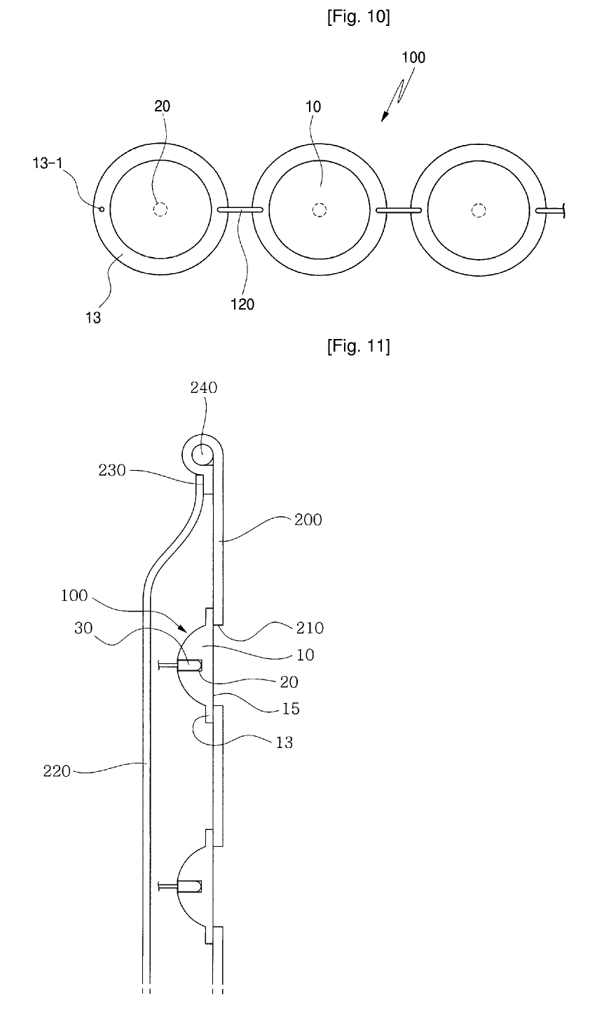

FIG. 10 is a top view of another embodiment of a diffused light-emitting unit of FIG. 4. As shown in FIG. 10, the edge unit (13) of the convex unit (10) of the diffused light-emitting unit 100 forms elongating holes (13-1) allowing elongating units 120 to be coupled thereto, such that the length of the diffused light-emitting units 100 can be gradually extended as the number of the elongating units increases.

Although the foregoing description is explained based on a horizontal-type placard base plate 200, it will be easily appreciated that the light-emitting lamps can also be installed to a vertical-type placard base plate. The vertical-type placard base plate and its back plate are also made of waterproofing materials.

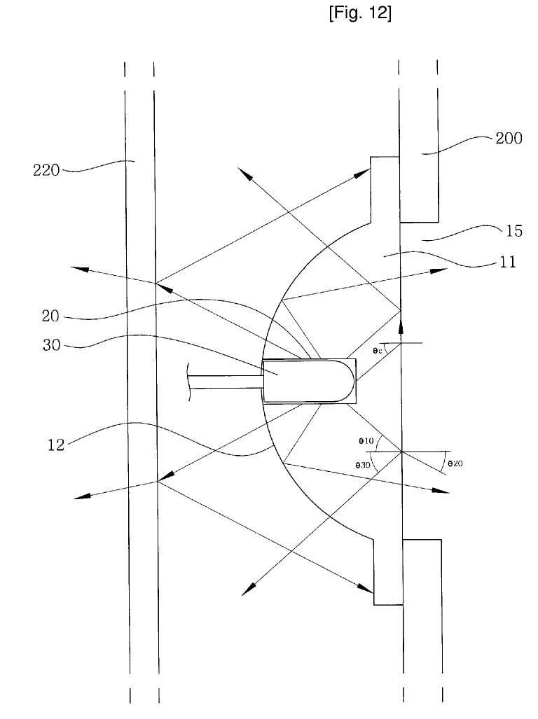

On the other hand, as shown in FIG. 11 of a cross-sectional view illustrating another embodiment of a light-emitting character placard according to the present invention, and FIG. 12 of an enlarged cross-sectional view of FIG. 11, the light-emitting character placard includes the following:

Diffusing light-emitting units 100, each with a surface that forms a flat plane, an inside that forms a core layer 11 transmitting light, and a bottom surface that forms a convex portion each a diffusing light-emitting unit for diffusing light of a light-emitting lamp 30 installed at the center of the bottom surface to the convex portion and the flat plane.

To form a character, a placard base plate 200 arrays the diffusing light-emitting units 100 at a certain distance.

A controller 130 controls power supplied to each diffusing light-emitting unit 100 coupled to the placard base plate 200.

A back plate 220 covers the entire backside of the placard base plate 200 using a sealing means 230. Also, the back plate 220 reflects/transmits the light emitted from the convex portion to the front side thereof.

Here, the diffusing light-emitting unit 100 includes: a convex lens-shaped convex portion 10, made of flexible thermoplastic (thermosetting) polymer to form a clad layer 12 that provides a reflection angle to emit light of an internal light source located therein with uniform illumination to a bottom surface thereof, in which the bottom surface forms a convex surface; an inserting hole 20 formed at the center of the bottom surface of the convex portion 10 along the axis; the light-emitting lamp 30 used as the internal light source, inserted into the insert hole 20; and a front surface (15) that emits the light of the convex portion 10 to the front side thereof, forming a plane consistent with the placard base plate 200.

Here, the convex unit 10 integrally joins its edge to a ring-plate-shaped supporting edge unit 13 that couples to the placard base plate 200.

The edge unit 13 of the convex unit 10 of the diffused light-emitting unit 100 is integrally and repeatedly coupled to the base body 110 with a certain length, such that the length of the edge of unit 13 can be gradually extended.

The edge unit 13 of the convex unit 10 forms elongating holes 13-1 that allows elongating units 120 to coupled thereto, such that the length of the diffused light-emitting units 100 can be gradually extended as the number of the elongating units increases.

In operations, when the front and side lobes of lights of the light-emitting lamp 30 used as a light source occur in the clad layer 12 forming the surface of the core layer 11 as shown in FIGS. 7 and 8, the diffused light-emitting unit 100 allows the lights to travel at an incident angle (θ 10) and refraction angle (θ20) with respect to the normal line of each point on the convex portion forming the clad layer 12, such that the surface of the convex portion 10 can emit the lights with uniform illumination. More specifically, although the light of the light-emitting lamp 30 travels straight in the core layer 11, the clad layer 12 forms a curved surface such that the incident angles (θ10, θ10′, and θ50) are less than the critical angle (θc) at most of the normal lines. Therefore, the light is transmitted through the convex surface at the refraction angles (θ20, θ20′, and θ60) with respect to the normal lines. Thus, the surface of the convex portion emits the lights with uniform illumination. (Namely, the present invention is not a concept that uses a light-emitting lamp 30 whose surface allows the light to just travel straight, but a concept that uses a diffused light-emitting unit diffusing light uniformly through the convex portion 10, which has a diameter greater than that of the light-emitting lamp 30 itself). As well, there are some portions where the light is reflected to the inside of the core layer 11 at incident angles (θ10, θ10′, and θ50) and reflection angles (θ30, θ30′, and θ40). But, such an internal reflection light contributes to illumination enhancement since it will be transmitted outside through another point after reflecting again in the core layer 11. Here, the clad layer 12 is a medium (for example, air) whose refractive index is different from that of the core layer 11 made of thermoplastic (thermosetting) synthesis resin polymer, such that the light traveling straight in the clad layer 11 can be refracted in the clad layer 12.

In addition, the clad layer 12 may further form a translucent layer on its surface so that the light can be dimly emitted. The core layer 11 may include micro-mineral particles, such as Titanium Dioxide etc., to be translucent, such that the light can transmit the translucent core layer.

Finally, the diffused light-emitting units 100 are arrayed on the placard base plate 200 to form a character (for example, a phrase “Congratulations on Election,” in Korean, as shown in FIG. 1) in such a way that they are spaced apart at a certain distance to be recognizable as a character. In an array manner, the diffused light-emitting unit 100 is coupled to the coupling hole 210 of the placard base plate 200 such that its convex portion 10 can be exposed, as shown in FIGS. 3 and 4, and its edge unit 13 is folded around the edge of the coupling hole 210 and fixed thereto by a coupling means, such as, a high frequency welder, bond or a clip, etc. Here, the character of the placard base plate 200 of FIG. 4 can be implemented by using the diffused light-emitting unit 100 of FIGS. 9 and 10.

After the placard base plate 200 according to the present invention forms a character or a figure, etc. using the diffused light-emitting units 100, each light-emitting lamp 30 of the diffused light-emitting unit 100 is connected to the controller 130 of FIG. 5 through an electrical line 133. Thereafter, as shown in FIG. 2 to 4, the back plate 220 covers the placard base plate 200 using a sealing means 230 (for example, a high frequency welding method), so that it can be waterproofing.

When a user operates a switch 131 to supply power from the built-in batter 132 to the controller 130, the light-emitting lamps 30, forming the character, emit lights, and thus the light-emitting character placard displays the character.

Importantly, since the diffused light-emitting unit 100 diffuses lights through a relatively broad light-emitting area to display a character, the light-emitting character placard can employ a relatively small number of light-emitting lamps 30 and display the character at a high level of illumination. Compared with the conventional placard, the light-emitting character placard of the present invention can reduce the number of light-emitting lamps 30 and thus decrease its cost. Also, since the convex portion 10 of the light-emitting unit allows the light to be diffused with uniform illumination, it can provide a dim light emitting effect, which protects user's eyes and such effect is favorably attractive to the user.

On the other hand, as shown in FIGS. 11 and 12, the present invention can be used for a double-layer light-emitting character placard. In this case, when front and side lobes of lights of the light-emitting lamp 30 used a light source occur in the clad layer 12 forming the surface of the core layer 11 as shown in FIG. 12, the diffused light-emitting unit 100 allows the lights reflected from the clad layer 12 of the convex portion 10 to travel at an incident angle (θ10) and refraction angle (θ20) with respect to the normal line of each point on the flat front surface 15, thereby diffusing the lights. When the traveling light is incident on the front surface at greater than critical angle (θc), it is not reflected. Therefore, the front surface 15 diffuses light by a single light-emitting lamp 30 in such a way that the diffused light-emitting unit 100 can emit light through its whole body.

In addition, as shown in FIG. 8, the diffused light-emitting unit 100 allows the lights to travel at an incident angle (10) and refraction angle (20) with respect to the normal line of each point on the convex portion forming the clad layer 12, such that the surface of the convex portion 10 can emit the lights with uniform illumination. More specifically, although the light of the light-emitting lamp 30 travels straight in the core layer 11, the clad layer 12 forms a curved surface such that the incident angles (θ10, θ10′, and θ50) are less than the critical angle (θc) at most of normal lines. Therefore, the light is transmitted through the convex surface at the refraction angles (θ20, θ20′, and θ60) with respect to the normal lines. Thus, the surface of the convex portion emits the lights with uniform illumination. (Namely, the present invention is not a concept that uses a light-emitting lamp 30 whose surface allows the light to just travel straight, but a concept that uses a diffused light-emitting unit diffusing light uniformly through the convex portion 10 having a diameter greater than that of the light-emitting lamp 30 itself). As well, there are some portions where the light is reflected to the inside of the core layer 11 at incident angles (θ10, θ10′, and θ50) and reflection angles (θ30, θ30′, and θ40). But, such an internal reflection light contributes to the illumination enhancement since it will be transmitted outside through other point after reflecting again in the core layer 11. Here, the clad layer 12 is a medium (for example, air) whose refractive index is different from that of the core layer 11 made of thermoplastic (thermosetting) synthesis resin polymer, such that the light traveling straight in the clad layer 11 can be refracted in the clad layer 12. As a result, such an operation allows the light to be diffused through the back plate 220 as shown in FIGS. 11 and 12. The present invention can display an advertisement through the front side of the placard base plate 200 and, simultaneously, perform an illumination advertisement at night through the back plate 220. Namely, the present invention can advertise through both plates. Additionally, since the back plate 220 reflects some of the light to the placard base plate 200, the edge of the diffused light-emitting unit 100 can be brighter allowing the diffused light-emitting unit to form dim illumination.

The diffused light-emitting units 100 are arrayed on the placard base plate 200 to form a character (for example, a phrase “Congratulations on Election,” in Korean, as shown in FIG. 1) in such a way that they are spaced apart at a certain distance to be recognizable as a character. In an array manner, the diffused light-emitting unit 100 is coupled to the coupling hole 210 of the placard base plate 200 such that its front surface 15 can be exposed, as shown in FIGS. 3 and 4, and its edge unit 13 is folded around the edge of the coupling hole 210 and fixed thereto by a coupling means, such as, a high frequency welder, bond or a clip, etc. Here, the character of the placard base plate 200 of FIG. 4 can be implemented by using the diffused light-emitting unit 100 of FIGS. 9 and 10, based on the same coupling manner as FIGS. 11 and 12.

Although the foregoing description explained that the back plate performs a reflection layer through FIGS. 11 and 12, it will be easily appreciated that an additional reflection plate may be adhered to a part of the flat front surface to shown various illumination effects. When the reflection plate is implemented with an opaque material, the light emits to only the front surface and, at the same time, the periphery of the diffused light-emitting unit is much brighter to form dim illumination. In this case, the light-emitting character placard has an aesthetically neat appearance due to the flatness of the front surface.

The present invention provides the light-emitting character placard to display characters. As well, for easy carrying, the light-emitting character placard can be folded or rolled. Also, since the light-emitting character placard employs a battery instead of an external power source, it can be used regardless of location. In addition, when the light-emitting lamps are replaced with LED's consuming less power, the light-emitting character placard can work for a relatively long time.

Further, since the diffused light-emitting unit diffuses light through a relatively broad light-emitting area to display a character, the light-emitting character placard can employ a relatively small number of light-emitting lamps and have an economical advantage.

Additionally, since the diffused light-emitting unit diffuses light through its convex surface with uniform illumination, it can reduce users' eye fatigue, and provide a soft visual quality that maximizes advertising effect.

Since the diffused light-emitting unit employs a battery, the light-emitting character placard is portable and can be used regardless of place. Importantly, since the light-emitting character placard does not need an additional lightening device to advertise at night, it can maximize an advertisement's effect economically.

Since characters on the light-emitting character placard can shine at night, it can be used for a simplified sign or an advertisement sign for short-term advertisement or display.

Since the diffused light-emitting unit uses a (flexible) placard so that the placard can be folded or rolled, the light-emitting character placard is conveniently portable and storable.

Also, when the light-emitting character placard employs a solar cell to power the light-emitting lamps, it can be used semi-permanently. Such a light-emitting character placard can be installed and updated conveniently regardless of its location. Also, the light-emitting character placard can function as a plain placard at day and as an electrical sign at night.

In addition, when the placard base plate and the back plate are made of waterproof cloth or synthetic resin sheet, the light-emitting character placard is aesthetically pleasing and does not cause a leak of electricity. Namely, the light-emitting character has various benefits, for example, it can be used in all-weather conditions and the back plate can function as another advertisement plate.

Further more, when the diffused light-emitting unit is coupled to the placard base plate in such a way that its convex portion is located at the rear side of the base plate and its flat portion is located at the front side of the base plate, the diffused light-emitting unit can emit light to both the front and rear sides, simultaneously. Therefore, the present invention can be a two-side light-emitting character placard.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

Since the light-emitting character placard according to the present invention can be manufactured using a small number of diffused light-emitting units mounted on its placard base plate, it is light and conveniently portable. Therefore, the light-emitting character placard can be widely used in applications, such as traffic signs, safety accident campaign signs, advertisement signs, child safety vests in kindergarten, night identification labels for child, simplified signs, various placards for night identification use (during Christmas, various night events, etc.)

1. A light-emitting character placard comprising:
a placard base plate (200) on which light-emitting lamps (30) are arrayed at a predetermined distance to form characters and coupled by sealing;
a controller (130) supplying power to each light-emitting lamps (30) and controlling the power; and
a back plate (220) covering the entire backside of the placard base plate (200) using a sealing means (230).

2. A light-emitting character placard comprising:
diffusing light-emitting units (100), each of which has a bottom surface forming a flat plane, an inside forming a core layer (11) transmitting light, and an upper surface forming a convex surface, each diffusing light-emitting unit for diffusing light of a light-emitting lamp (30) installed on the bottom surface to the convex surface;
a placard base plate (200) arraying the diffusing light-emitting units (100) at a certain distance to form a character;
a controller (130) controlling power supplied to each diffusing light-emitting unit (100) coupled to the placard base plate (200); and
a back plate (220) covering the entire backside of the placard base plate (200) using a sealing means (230),
wherein the diffusing light-emitting unit (100) includes:
a convex portion (10) shaped as a convex lens, being made of flexible thermoplastic (thermosetting) polymer to form a clad layer (12) providing a reflection angle to emit light of an internal light source located therein with uniform illumination to upper surface thereof, in which the upper surface forms a convex surface;
an inserting hole (20) formed at the center of a bottom surface of the convex portion (10) along the axis;
the light-emitting lamp (30) used as the internal light source, inserted into the insert hole (20); and
a reflection layer (40) integrally coupled to the flat plane of the bottom surface of the convex unit (10),
wherein a supporting edge unit (13) shaped as a ring-plate for coupling to the placard base plate (200) is integrally coupled to an edge of the convex unit (10).

3. The placard according to claim 2, wherein the placard base plate (200) forms coupling holes (210) coupling to and supporting the diffused light-emitting units (100), in such a way that the diffused light-emitting units (100) are spaced apart from each other to be recognizable as the character.

4. The placard according to claim 2, wherein the sealing means (230) includes a zipper, a high frequency welder, and a magic tape.

5. The placard according to claim 2, wherein the placard base plate (200) couples a supporting band (240) to an edge thereof.

6. The placard according to claim 2, wherein the edge unit (13) of the convex unit (10) is integrally and repeatedly coupled to the base body (110) with a certain length, such that the length of the edge unit (13) can be gradually extended.

7. The placard according to claim 2, wherein the edge unit (13) of the convex unit (10) forms elongating holes (13-1) allowing elongating units (120) to coupled thereto, such that the length of the diffused light-emitting units (100) can be gradually extended as the number of the elongating units increases.

8. A light-emitting character placard comprising:
diffusing light-emitting units (100), each of which has a surface forming a flat plane, an inside forming a core layer (11) transmitting light, and a bottom surface forming a convex portion, each diffusing light-emitting unit for diffusing light of a light-emitting lamp (30) installed at the center of the bottom surface to the convex portion and the flat plane;
a placard base plate (200) arraying the diffusing light-emitting units (100) at a certain distance to form a character;
a controller (130) controlling power supplied to each diffusing light-emitting unit (100) coupled to the placard base plate (200); and
a back plate (220) covering the entire backside of the placard base plate (200) using a sealing means (230), and reflecting/transmitting the light emitted from the convex portion to the front side thereof,
wherein the diffusing light-emitting unit (100) includes:
a convex portion (10) shaped as a convex lens, being made of flexible thermoplastic (thermosetting) polymer to form a clad layer (12) providing a reflection angle to emit light of an internal light source located therein with uniform illumination to the bottom surface thereof, in which the bottom surface forms a convex surface;
an inserting hole (20) formed at the center of a bottom surface of the convex portion (10) along the axis;
the light-emitting lamp (30) used as the internal light source, inserted into the insert hole (20); and
a front surface (15) for emitting the light of the convex portion (10) to the front side thereof, and forming a plane consistent with the placard base plate (200),
wherein the ring-shaped convex unit (10) integrally couples its edge to a supporting edge unit (13) to couple to the placard base plate (200).

9. The placard according to claim 8, wherein the edge unit (13) of the convex unit (10) is integrally and repeatedly coupled to the base body (110) with a certain length, such that the length of the edge unit (13) can be gradually extended.

10. The placard according to claim 8, wherein the edge unit (13) of the convex unit (10) forms elongating holes (13-1) allowing elongating units (120) to coupled thereto, such that the length of the diffused light-emitting units (100) can be gradually extended as the number of the elongating units increases.
